(19) United States
(12) Patent Application Publication
(10) Pub. No.: US 2022/0105549 A1
(43) Pub. Date: Apr. 7, 2022

(54) FLY ASH TREATMENT METHOD, METHOD FOR OBTAINING METAL HYDROXIDE AND METHOD FOR PREPARING INDUSTRIAL SALT

(71) Applicant: WELL CYCLE CENTRAL INVEST CO., LTD., Kaohsiung City (TW)

(72) Inventor: Chi-Huang LEE, Kaohsiung City (TW)

(21) Appl. No.: 17/482,425

(22) Filed: Sep. 23, 2021

(30) Foreign Application Priority Data
Oct. 6, 2020 (TW) 109134636

(51) Int. Cl. B09B 3/00; F23J 1/02; C01D 1/04; C01F 1/00

(52) U.S. Cl. CPC B09B 3/0016; F23J 1/02; C01D 1/04; F23J 2217/50; B09B 2220/06; F23J 2700/001; C01F 1/00

(57) ABSTRACT

A fly ash treatment method includes: a setting step: finding out an initial viscosity value of initial fly ash; a pickling operation step: adding the initial fly ash, water and an acid to a pickling tank, uniformly stirring the mixture, and detecting and adjusting a ratio of components of slurry in the pickling tank to conform to a variation of the curve in the heavy metal leaching test curve graph; a first quantitative output step: inputting the slurry into a first buffer tank and quantitatively output the slurry; a first filtration step: filtering fine particles in the slurry output by from the first buffer tank; a drying and pulverizing step: removing water from the slurry passing through the first filter, and performing pulverizing to form powder; and a rotary kiln cracking step: cracking organic matters in the powder by a rotary kiln, and collecting fly ash cinder.

### CROSS-REFERENCE TO RELATED APPLICATION

This application claims the benefit of Taiwan Patent Application No. 109134636, filed on 6 Oct. 2020, which is hereby incorporated by reference for all purposes as if fully set forth herein.

### BACKGROUND

### Technical Field

This invention relates to a fly ash treatment method, a method for obtaining a metal hydroxide and a method for preparing an industrial salt, in particular to a fly ash treatment method, a method for obtaining a metal hydroxide and a method for preparing an industrial salt, which are capable of reducing amounts of water and acid used during separation of heavy metals.

### Related Art

Literally, fly ash is fine particles flying in the air. It is a solid residual granular substance produced after combustion or incineration of substances and can escape from waste gas. Combustion processes that produce fly ash include fossil fuel combustion, boiler combustion, waste incineration and the like. Fly ash is mainly composed of suspended particles, dust, bituminous coal, or metal particles and oxides produced during combustion.

In view of the fact that the fly ash contains many harmful heavy metal substances, if the fly ash is buried, the leached harmful heavy metal substances will have an impact on the environment and ecology. Therefore, it is a problem on how to effectively treat the incineration fly ash such that the incineration fly ash becomes a recyclable material, thereby creating the reusability of the incineration fly ash.

Fly ash contains large amounts of chlorides/oxides of alkali metals and alkaline earth metals such as Ca, Na, K, Mg and the like, and thus, is a highly alkaline substance (with a pH of about 10.5-12.3). Common methods for removing harmful heavy metals leached include chemical stabilization. For example, Taiwan Patent Publication No. TWI552811B discloses a “Method for Treating Incineration Fly Ash Containing Harmful Heavy Metals”. The method includes the following steps. (a) Water is added to incineration fly ash containing harmful heavy metals, and the mixture is heated to 50 to 80° C. and stirred. During the stirring, quartz sand is added, and an ultrasonic generator is used to deliver ultrasonic waves with a power of 150 to 300 W. The action time is controlled at 2.5 to 10 minutes such that a solid-liquid slurry is formed. (b) The solid-liquid slurry is sent by a pressure pump into a wet vortex cone classifier to isolate the harmful heavy metals.

However, during the treatment of the fly ash in this patent, especially during water washing, it is very easy to cause unnecessary waste of water resources because of the incapability of mastering an appropriate and good ratio.

In addition, Chinese Patent Publication No. CN108179277B discloses a “Method for Treating High-salt High-heavy-metal-content Fly Ash”. The method includes the following steps. A pickling solution is used to wash fly ash. By controlling a liquid-to-solid ratio, soluble salts in the fly ash are transferred into the pickling solution to the greatest extent to obtain concentrated brine with recovery value. After the obtained concentrated brine is separated to recover salts, the residual solution returns to the flow as a replenisher for washing next batch of fly ash. The washed fly ash is subjected to acid leaching with an acid leaching solution. By controlling a liquid-to-solid ratio, the heavy metals in the fly ash enter the leaching solution to the greatest extent to obtain a heavy metal leaching solution with recovery value. After the heavy metal leaching solution is separated to recover the heavy metals, the residual solution is used as a leaching replenisher for leaching next batch of fly ash. After the acid leaching, the fly ash is subjected to a staged washing process to remove residual heavy metal ions and incompletely leached heavy metals, so that the leaching toxicity of the fly ash reaches the standard and the fly ash becomes harmless.

However, the above patent only provided the concepts that “the fly ash is subjected to acid leaching with an acid leaching solution, and by controlling a liquid-to-solid ratio, the heavy metals in the fly ash enter the leaching solution to the greatest extent”, and did not disclose in detail the liquid-to-solid ratio and the relationship between the ratio of components in the pickling solution and the pH, thus easily causing large amounts of waste water and waste of acid, resulting in waste of production costs and environmental hazards.

### SUMMARY

An objective of this invention is to provide a fly ash treatment method. A pre-tested heavy metal leaching dynamic test curve and a viscosity variation curve of different liquid-to-solid ratios are used to determine a ratio of pretreated fly ash to water to acid. During the reaction, the pH of the mixed slurry is monitored, and the ratio of water to acid is properly adjusted according to the heavy metal leaching dynamic test curve to obtain a good heavy metal leaching effect.

In order to achieve the above objective, this invention provides a fly ash treatment method, including: a setting step: comparing pH of initial fly ash with pH at initial reaction time in a heavy metal leaching test curve graph to obtain a liquid-to-solid ratio corresponding to the curve closest to the pH, finding out a viscosity value corresponding to the liquid-to-solid ratio according to the liquid-to-solid ratio via a viscosity variation curve graph of different liquid-to-solid ratios to serve as an initial viscosity value of the initial fly ash; a pickling operation step: adding the initial fly ash, water and an acid in an initial ratio to a pickling tank, and uniformly stirring the mixture into a slurry such that heavy metals in the initial fly ash react with the water and the acid to elute the heavy metals, wherein the ratio of the initial fly ash to the water is adjusted to conform to the initial viscosity value, and the pickling operation step includes a pH control unit, configured to detect pH of the solution in the pickling tank and control the ratio of the water to the acid to adjust the pH of the solution in the pickling tank such that a corresponding relationship between the pH of the solution and the reaction time conforms to a variation of the selected curve in the heavy metal leaching test curve graph; a first quantitative output step: inputting the slurry in the pickling tank after the pickling operation into a first buffer tank, and outputting the slurry from the first buffer tank at a controllable output quantity; a first filtration step: collecting, by a first filter, a plurality of fine particles of carbon particles and heavy metal components in the slurry output from the first buffer tank; a drying and pulverizing step: removing water from the slurry passing through the first filter to form a dry solid, and pulverizing the dry solid to form powder with a uniform particle size; and a rotary kiln cracking step: cracking, by a rotary kiln, organic matters in the powder, and collecting, by a hopper, fly ash cinder generated after the cracking.

In some examples, a weight ratio of the initial fly ash to the water to the acid in the initial ratio is 1:(4-7):(1-4).

In some examples, in the pickling operation step, the acid added to the pickling tank is waste acid, and in the pH control unit, a manner for controlling the ratio of the water to the acid is to adjust an acid value of the pickling tank by adding a controllable amount of pure acid to the pickling tank.

In some examples, the pH control unit in the pickling operation step measures the pH of the slurry in the pickling tank by a pH meter arranged in the pickling tank.

In some examples, the pickling operation step further includes adding an oxidizer 14 to the pickling tank, and a coagulant is further added to the first buffer tank in the first quantitative output step.

In some examples, the fine particles collected by the first filter in the first filtration step are added back to the first buffer tank many times for cycle filtration.

In some examples, the first filtration step includes rinsing the first filter with water.

Another objective of this invention is to provide a method for obtaining a metal hydroxide, which is a product obtained by carrying out acid-base neutralization on the heavy metal components collected by the first filter in the above-mentioned fly ash treatment method and then carrying out filtration and drying.

In order to achieve the above objective, the method includes: carrying out the setting step, the pickling operation step, the first quantitative output step and the first filtration step according to the above-mentioned method; a second quantitative output step: collecting, by a second buffer tank, the fine particles collected by the first filter in the first filtration step; an acid-base neutralization step: adding the fine particles quantitatively output from the second buffer tank to a neutralizing tank, adding a uniformly mixed solution of water and lime to the neutralizing tank, and uniformly mixing the mixture in the neutralizing tank; a third quantitative output step: collecting, by a third buffer tank, the slurry in the neutralizing tank; a second filtration step: collecting, by a second filter, the plurality of fine particles of carbon particles and heavy metal components in the slurry output from the third buffer tank; and a drying and dehydration step: drying and dehydrating the slurry passing through the second filter to obtain a metal hydroxide.

In some examples, the first filtration step includes rinsing the first filter with water, and the second filtration step includes rinsing the second filter with water.

Still another objective of this invention is to provide a method for preparing an industrial salt, which is an industrial salt product obtained by carrying out vacuum concentration on the slurry filtered by the second filter in the above-mentioned method for obtaining a metal hydroxide to obtain high-salt brine and then drying the high-salt brine.

This invention has the following characteristics. According to this invention, true empirical data are applied to determine the solid ratio of fly ash to water and acid in the early stage and the weight ratio of water to acid during the pickling reaction during the pickling for treating fly ash, and the pH of the pickling solution can be adjusted in real time during the pickling reaction, so that harmful heavy metals are efficiently separated from the fly ash slurry within a preset time by using the least amounts of water and acid, so as to obtain the harmless fly ash cinder. Further, the separated heavy metal slurry can be subjected to acid-base neutralization, filtration and drying to obtain the metal hydroxide. The slurry obtained after the acid-base neutralization and the filtration can be subjected to the vacuum concentration step to form the high-salt brine, and the high-salt brine can be dried to obtain the industrial salt product. In the pickling operation step according to this invention, the acid added may be recycled and reused waste acid, and when adjusting the pH of the acid in the pickling tank during the reaction, the pure acid can be added to the pickling tank to change the pH, thereby achieving the effect of reducing acid costs.

### BRIEF DESCRIPTION OF THE DRAWINGS

FIG. 1 is a heavy metal leaching dynamic test curve graph applied by an example of this invention;

FIG. 2 is a viscosity variation graph of different solid-to-liquid ratios applied by an example of this invention;

FIG. 3 is a flowchart of a fly ash treatment method according to an example of this invention;

FIG. 4 shows a method for obtaining a metal hydroxide by applying a fly ash treatment technology according to an example of this invention;

FIG. 5 shows a method for preparing an industrial salt by applying a fly ash treatment technology according to an example of this invention; and

FIG. 6 is a schematic diagram of treatment methods of FIG. 3 to FIG. 5 according to this invention.

### DETAILED DESCRIPTION

Embodiments of this invention are described in detail below with reference to the accompanying drawings. The accompanying drawings are mainly simplified schematic diagrams, and only exemplify the basic structure of this invention schematically. Therefore, only the components related to this invention are shown in the drawings, and are not drawn according to the quantity, shape, and size of the components during actual implementation. During actual implementation, the specification and size of the components are actually an optional design, and the layout of the components may be more complicated.

The following description of various embodiments is provided to exemplify the specific embodiments for implementation of this invention with reference to accompanying drawings. The directional terms mentioned in this invention, such as “above”, “below”, “front”, “back”, “left”, “right”, “in”, “out”, and “side”, merely refer to the directions in the accompanying drawings. Therefore, the used terms about directions are used to describe and understand this invention, and are not intended to limit this invention. In addition, in the specification, unless explicitly described as contrary, the word “include” is understood as including the component, but does not exclude any other components.

### Embodiment 1

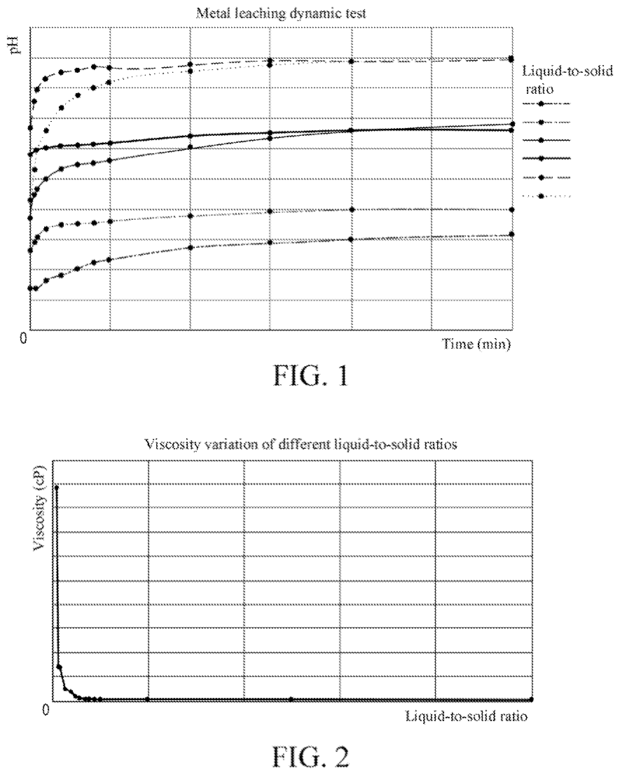

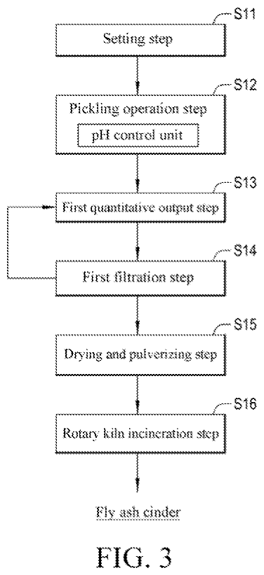

With reference to FIG. 1, FIG. 2, FIG. 3 and FIG. 6, a fly ash treatment method in this example includes: a setting step (step S11), a pickling operation step (step S12), a first quantitative output step (step S13), a first filtration step (step S14), a drying and pulverizing step (step S15) and a rotary kiln cracking step (step S16).

In the setting step (step S11), pH of initial fly ash 11 is compared with pH at initial reaction time in a heavy metal leaching test curve graph P1 (the horizontal axis denotes time and the vertical axis denotes pH) to obtain a liquid-to-solid ratio corresponding to the curve closest to the pH, a viscosity value corresponding to the liquid-to-solid ratio is found out according to the liquid-to-solid ratio via a viscosity variation curve graph of different liquid-to-solid ratios P2 (the horizontal axis denotes liquid-to-solid ratio and the vertical axis denotes viscosity) to serve as an initial viscosity value of the initial fly ash 11.

In the pickling operation step (step S12), the initial fly ash 11, water 12 and an acid 13 in an initial ratio are added to a pickling tank 2, and the mixture is uniformly stirred into a slurry (for example, by a motor stirrer) such that heavy metals in the initial fly ash 11 react with the water 12 and the acid 13 to elute the heavy metals. The ratio of the initial fly ash 11 to the water 12 is adjusted to conform to the initial viscosity value. The pickling operation step (step S12) further includes a pH control unit 23, configured to detect pH of the slurry 21 in the pickling tank 2 and adjust the ratio of the components of the slurry 21 in the pickling tank 2 such that a corresponding relationship between the pH of the slurry 21 and the reaction time conforms to a variation of the selected curve in the heavy metal leaching test curve graph P1. Thus, the optimal heavy metal leaching can be achieved with a smaller amount of water within the same reaction time.

In the first quantitative output step (step S13): the slurry 21 in the pickling tank 2 after the pickling operation is input into a first buffer tank 3, and the slurry 31 is output from the first buffer tank 3 at a controllable output quantity. Certainly, in order to enhance the sedimentation effect of the first buffer tank 3, a coagulant 32 may be added to the first buffer tank 3.

In the first filtration step (step S14), a plurality of fine particles 41 of carbon particles and heavy metal components in the slurry 31 output from the first buffer tank 3 are collected by a first filter 4.

In the drying and pulverizing step (step S15), water is removed from the slurry 42 passing through the first filter 4 to form a dry solid while the temperature can be accurately controlled, and the dry solid is pulverized to form non-caking powder 44 with a uniform particle size.

In the rotary kiln cracking step (step S16): the powder 44 is cracked by a rotary kiln with uniform heating, and fly ash cinder 52 generated after the cracking is collected by a hopper 51, so that the fly ash cinder 52 without harmful substances is obtained.

In an example, a ratio of the initial fly ash 11 to the water 12 to the acid 13 in the initial ratio is 1:(4-7):(1-4).

In some examples, in the pickling operation step (step S12), the acid 13 added to the pickling tank 2 is recyclable waste acid 131, and in the pH control unit 23, a manner for controlling the ratio of the water 12 to the acid 13 is to adjust an acid value of the pickling tank 2 by adding a controllable amount of pure acid 132 to the pickling tank 2 (for example, adding the pure acid 132 may reduce the acid value, and adding the water 12 may increase the acid value).

In some examples, the pH control unit 23 in the pickling operation step (step S12) measures the pH of the slurry 21 in the pickling tank 2 by a pH meter 22 arranged in the pickling tank 2 and reports the pH back to the pH control unit 23.

In some examples, the fine particles 41 (containing heavy metals and carbon powder) collected by the first filter 4 in the first filtration step (step S14) are added back to the first buffer tank 3 many times for cycle filtration, so as to increase the precipitation rate of the heavy metals. Certainly, in the first filtration step (step S14), the first filter 4 may be rinsed with water 43 to change the viscosity of the slurry 42, so as to enhance the filtration effect of the first filter 4.

### Embodiment 2

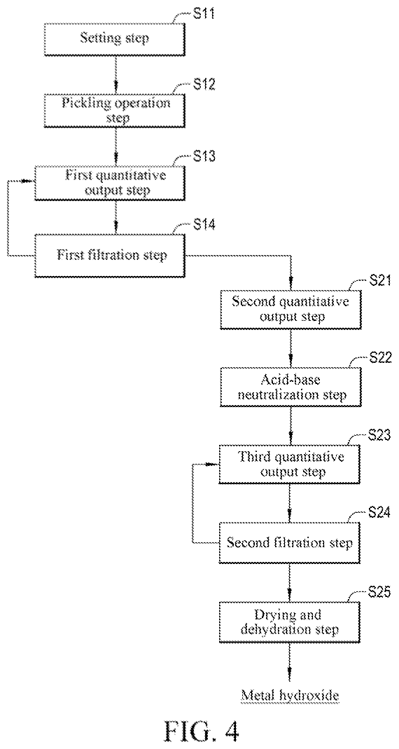

With continued reference to FIG. 4 and FIG. 6, a method for obtaining a metal hydroxide 641 by applying a fly ash treatment technology in this example includes the following steps. The setting step (step S11), the pickling operation step (step S12), the first quantitative output step (step S13) and the first filtration step (step S14) are carried out.

Then, a second quantitative output step (step S21) is carried out. The fine particles 41 containing heavy metals collected by the first filter 4 in the first filtration step (step S14) are collected by a second buffer tank 6.

Then, an acid-base neutralization step (step S22) is carried out. The fine particles 41 quantitatively output from the second buffer tank 6 are added to a neutralizing tank 61, a uniformly mixed lime water 611 solution of water and lime is added to the neutralizing tank 61, and the mixture is uniformly mixed in the neutralizing tank 61 (for example, stirred by a motor stirrer).

Then, a third quantitative output step (S23) is carried out. The slurry in the neutralizing tank 61 is collected by a third buffer tank 62 and quantitatively output.

Then, a second filtration step (step S24) is carried out. The slurry (a plurality of fine particles containing carbon particles and heavy metal components) output from the first buffer tank 62 is collected by a second filter 63.

A drying and dehydration step (step S25) is carried out. The slurry passing through the second filter 63 is dried and dehydrated to obtain a metal hydroxide 641 product.

In an improved example based on the second example, the first filtration step (step S14) includes rinsing the first filter 4 with water 43, and the second filtration step (step S24) includes rinsing the second filter 63 with water 631.

### Embodiment 3

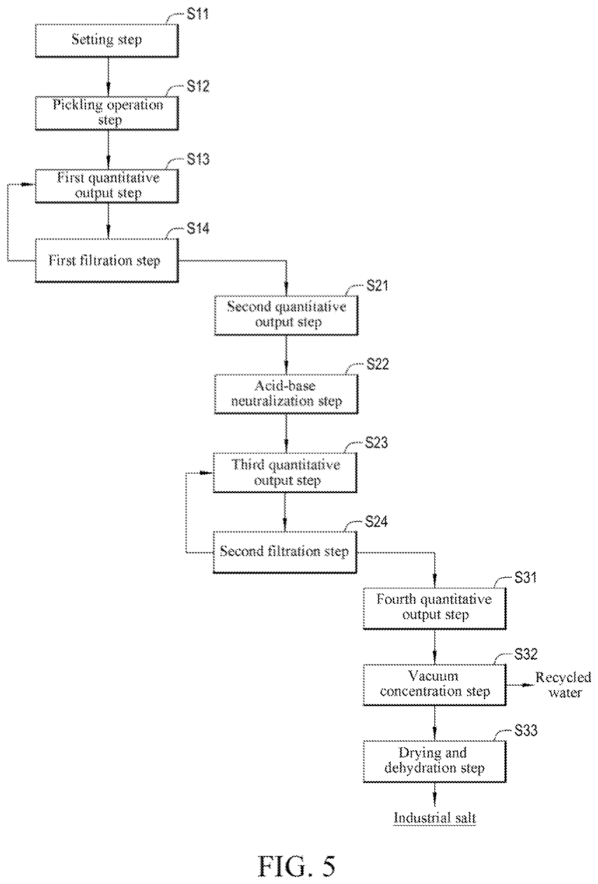

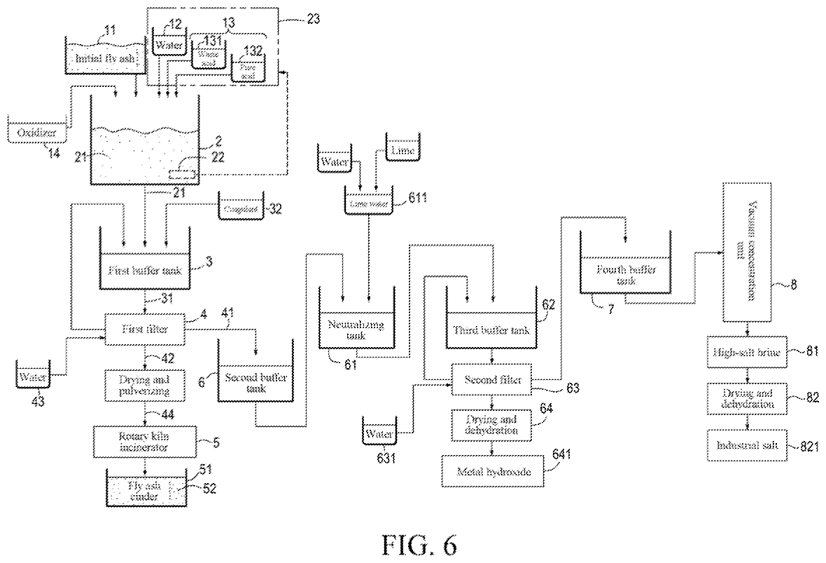

With reference to FIG. 5 and FIG. 6, a method for preparing an industrial salt by applying a fly ash treatment technology in this example includes the following steps. The setting step (step S11), the pickling operation step (step S12), the first quantitative output step (step S13), the first filtration step (step S14), the second quantitative output step (step S21), the acid-base neutralization step (step S22), the third quantitative output step (step S23) and the second filtration step (step S24) as described in the second example are carried out.

Then, a fourth quantitative output step (step S31) is carried out. The fine particles collected by the second filter 63 in the second filtration step (step S24) are collected by a fourth buffer tank 7.

Then, a vacuum concentration step (step S32) is carried out. The slurry is quantitatively output to a vacuum concentration unit 8 by the fourth buffer tank 7, and the slurry is concentrated into high-salt brine 81.

A drying and dehydration step (step S33) is carried out. The high-salt brine 81 is subjected to a drying and dehydration 82 process to prepare the industrial salt 821.

The foregoing embodiments merely exemplify the principles, features, and effects of this invention, but are not intended to limit the implementation scope of this invention. A person skilled in the art may modify or change the above embodiments without departing from the spirit and scope of this invention. Any equivalent change or modification made using the contents disclosed by this invention shall fall within the scope of the claims below.

What is claimed is:

1. A fly ash treatment method, comprising:
a setting step: comparing pH of initial fly ash with pH at initial reaction time in a heavy metal leaching test curve graph to obtain a liquid-to-solid ratio corresponding to the curve closest to the pH, finding out a viscosity value corresponding to the liquid-to-solid ratio according to the liquid-to-solid ratio via a viscosity variation curve graph of different liquid-to-solid ratios to serve as an initial viscosity value of the initial fly ash;
a pickling operation step: adding the initial fly ash, water and an acid in an initial ratio to a pickling tank, and uniformly stirring the mixture into a slurry such that heavy metals in the initial fly ash react with the water and the acid to elute the heavy metals, wherein the ratio of the initial fly ash to the water is adjusted to conform to the initial viscosity value, and the pickling operation step comprises a pH control unit, configured to detect pH of the slurry in the pickling tank and adjust the ratio of components of the slurry in the pickling tank such that a corresponding relationship between the pH of the slurry and the reaction time conforms to a variation of a selected curve in the heavy metal leaching test curve graph;
a first quantitative output step: inputting the slurry in the pickling tank after the pickling operation into a first buffer tank, and outputting the slurry from the first buffer tank at a controllable output quantity;
a first filtration step: collecting, by a first filter, a plurality of fine particles of carbon particles and heavy metal components in the slurry output from the first buffer tank;
a drying and pulverizing step: removing water from the slurry passing through the first filter to form a dry solid, and pulverizing the dry solid to form powder with a uniform particle size; and
a rotary kiln cracking step: cracking, by a rotary kiln, organic matters in the powder, and collecting, by a hopper, fly ash cinder generated after the cracking.

2. The fly ash treatment method according to claim 1, wherein a weight ratio of the initial fly ash to the water to the acid in the initial ratio is 1:(4-7):(1-4).

3. The fly ash treatment method according to claim 1, wherein in the pickling operation step, the acid added to the pickling tank is waste acid, and in the pH control unit, a manner for controlling the ratio of the water to the acid is to adjust an acid value of the pickling tank by adding a controllable amount of pure acid to the pickling tank.

4. The fly ash treatment method according to claim 1, wherein the pH control unit in the pickling operation step measures the pH of the slurry in the pickling tank by a pH meter arranged in the pickling tank.

5. The fly ash treatment method according to claim 1, wherein the pickling operation step further comprises adding an oxidizer to the pickling tank, and a coagulant is further added to the first buffer tank in the first quantitative output step.

6. The fly ash treatment method according to claim 1, wherein the fine particles collected by the first filter in the first filtration step are added back to the first buffer tank many times for cycle filtration.

7. The method for treating fly ash according to claim 1, wherein the first filtration step comprises rinsing the first filter with water.

8. A method for obtaining a metal hydroxide by applying a fly ash treatment technology, comprising:
carrying out the setting step, the pickling operation step, the first quantitative output step and the first filtration step according to claim 1;
a second quantitative output step: collecting, by a second buffer tank, the fine particles collected by the first filter in the first filtration step;
an acid-base neutralization step: adding the fine particles quantitatively output from the second buffer tank to a neutralizing tank, adding a uniformly mixed solution of water and lime to the neutralizing tank, and uniformly mixing the mixture in the neutralizing tank;
a third quantitative output step: collecting, by a third buffer tank, slurry in the neutralizing tank;
a second filtration step: collecting, by a second filter, the slurry containing the plurality of fine particles of heavy metal components output from the third buffer tank; and
a drying and dehydration step: drying and dehydrating the slurry passing through the second filter to obtain a metal hydroxide.

9. The method for obtaining a metal hydroxide by applying a fly ash treatment technology according to claim 8, wherein the first filtration step comprises rinsing the first filter with water, and the second filtration step comprises rinsing the second filter with water.

10. A method for preparing an industrial salt by applying a fly ash treatment technology, comprising:
carrying out the setting step, the pickling operation step, the first quantitative output step, the first filtration step, the second quantitative output step, the acid-base neutralization step, the third quantitative output step and the second filtration step according to claim 8;
a fourth quantitative output step: collecting, by a fourth buffer tank, the fine particles collected by the second filter in the second filtration step;
a vacuum concentration step: quantitatively outputting the slurry to a vacuum concentration unit by the fourth buffer tank, and concentrating the slurry into high-salt brine; and
a drying and dehydration step: drying and dehydrating the high-salt brine to prepare the industrial salt.
